(19) United States
(12) Patent Application Publication
(10) Pub. No.: US 2025/0192270 A1
(43) Pub. Date: Jun. 12, 2025

(54) BATTERY SYSTEM FOR AN ELECTRIC VEHICLE

(71) Applicants: HYUNDAI MOTOR COMPANY, Seoul (KR); KIA CORPORATION, Seoul (KR)

(72) Inventors: Gyung Hoon Shin, Seoul (KR); Chan Sol Kim, Seoul (KR); Jong Gyu Park, Hwaseong-si (KR)

(73) Assignees: HYUNDAI MOTOR COMPANY, Seoul (KR); KIA CORPORATION, Seoul (KR)

(21) Appl. No.: 18/657,261

(22) Filed: May 7, 2024

(30) Foreign Application Priority Data
Dec. 6, 2023 (KR) 10-2023-0175953

(51) Int. Cl. H01M 10/6556; B60K 1/04; B60K 11/02; B60L 50/60; B60L 50/64; B62D 21/02; H01M 10/613; H01M 10/625; H01M 10/656; H01M 50/204; H01M 50/249

(52) U.S. Cl. CPC H01M 10/6556; B60K 1/04; B60K 11/02; B60L 50/64; B60L 50/66; H01M 10/613; H01M 10/625; H01M 10/656; H01M 50/204; H01M 50/249; B60K 2001/0438; B62D 21/02; H01M 2220/20

(57) ABSTRACT

A battery system for an electric vehicle includes a plurality of battery packs mounted, in an interchangeable manner, to a plurality of pack-installed locations successively arranged in a longitudinal direction of the electric vehicle; a plurality of cooling blocks provided respectively above the battery packs; a refrigerant supply pipe arranged at a first side of the plurality of pack-installed locations while extending in the longitudinal direction, and formed to supply a refrigerant to the cooling blocks; and a refrigerant recovery pipe arranged at a second side of the plurality of pack-installed locations while extending in the longitudinal direction and formed to recover the refrigerant from the cooling blocks.

### CROSS REFERENCE TO RELATED APPLICATIONS

This application claims priority to Korean Patent Application No. 10-2023-0175953, filed Dec. 6, 2023, the entire contents of which are incorporated herein by reference.

### BACKGROUND

### 1. Technical Field

The present disclosure relates to a battery system mounted to an electric vehicle and, more particularly, to a cooling device of a battery system.

### 2. Description of the Related Art

Electric vehicles are equipped with battery systems for supplying electric power to motors that generate a driving force of the electric vehicles.

In recent, the electric vehicles use exchangeable battery systems to overcome the issue of relatively long charging time.

Meanwhile, the battery system must be equipped with an appropriate cooling device to ensure stable output.

The description provided above as a related art of the present disclosure is just for helping understand the background of the present disclosure and should not be construed as being included in the related art known by those having ordinary skill in the art.

### SUMMARY

The present disclosure provides a battery system for an electric vehicle. The battery system is configured to selectively mount a plurality of battery packs in a vehicle as necessary and to selectively perform cooling only for the mounted battery packs so as to maximize energy efficiency of the electric vehicle and to maintain stable output performance of the battery system, and eventually, to significantly improve marketability of the electric vehicle.

In order to achieve the above-mentioned objective, a battery system for an electric vehicle in one embodiment of the present disclosure may include: a plurality of battery packs mounted, in an interchangeable manner, to a plurality of pack-installed locations successively arranged in a longitudinal direction of a vehicle; and a plurality of cooling blocks provided respectively above the battery packs. The battery system further includes: a refrigerant supply pipe arranged at a first side of the plurality of pack-installed locations while extending in the longitudinal direction of the vehicle, and the refrigerant supply pipe is formed to supply a refrigerant to the cooling blocks. The battery system further includes a refrigerant recovery pipe arranged at a second side of the plurality of pack-installed locations while extending in the longitudinal direction of the vehicle and formed to recover the refrigerant from the cooling blocks.

In one embodiment, the cooling blocks and the refrigerant supply pipe, and the cooling blocks and the refrigerant recovery pipe may be arranged so that a refrigerant supplying state and a refrigerant blocking state may be switched from each other according to a vertical relative displacement of the cooling blocks to the refrigerant supply pipe and the refrigerant recovery pipe.

In one embodiment, the pack-installed locations may be spaces partitioned by: i) side members constituting a frame of the vehicle and arranged at opposite portions of the frame while extending in the longitudinal direction; and ii) a plurality of cross members arranged while extending in a transverse direction of the vehicle to connect one of the side members to another side member (e.g., opposite side members).

The refrigerant supply pipe and the refrigerant recovery pipe may be respectively installed inside the opposite side members.

In one embodiment, upward bending pipes may be respectively connected to the refrigerant supply pipe and the refrigerant recovery pipe, each bending pipe being arranged for each pack-installed location, so that the refrigerant supply pipe and the refrigerant recovery pipe may be connected to the cooling blocks through in-vehicle body portions of the side members.

In another embodiment, each of the cooling blocks may have block nipples at opposite portions thereof and the block nipples may allow each of the cooling blocks to be removably coupled to the bending pipe of the refrigerant supply pipe and the bending pipe of the refrigerant recovery pipe by moving vertically against the frame.

In one embodiment, the bending pipes and the block nipples respectively may have shut-off valves. When the bending pipes and the block nipples are coupled to each other, the shut-off valves may allow the refrigerant to flow. When the bending pipes and the block nipples are separated from each other, the shut-off valves block the refrigerant from flowing.

In one embodiment, the refrigerant supply pipe and the refrigerant recovery pipe may respectively include pipe nipples having screw threads on outer circumferential surfaces thereof, and the pipe nipples may penetrate through the side members to be coupled to the bending pipes. Fixing nuts may be coupled to the screw threads of the pipe nipples and may fix the refrigerant supply pipe and the refrigerant recovery pipe to the side members.

A thermal interface material may be provided between each of the cooling blocks and each of the battery packs.

Furthermore, in order to achieve the above-mentioned objective, a battery system for an electric vehicle of the present disclosure includes: a frame providing a plurality of pack-installed locations in a longitudinal direction of a vehicle by a plurality of cross members connecting at least two side members to each other; and one or more battery packs provided in the plurality of pack-installed locations in an exchangeable manner. The battery system further includes: cooling blocks separately provided for the pack-installed locations to perform heat conduction with upper surfaces of the battery packs; and a refrigerant flow apparatus provided in the frame to supply and recover a refrigerant that circulates through the cooling blocks.

The refrigerant flow apparatus may include a refrigerant supply pipe and a refrigerant recovery pipe provided in the two side members of the frame and configured to send and receive the refrigerant to and from the cooling blocks, respectively.

The refrigerant supply pipe and the refrigerant recovery pipe may respectively have a plurality of pipe nipples that penetrate through in-vehicle body surfaces of the side members. In one embodiment, fixing nuts may be fastened to the pipe nipples to fix the refrigerant supply pipe and the refrigerant recovery pipe to the side members.

Each pipe nipple provided in the refrigerant supply pipe and each pipe nipple provided in the refrigerant recovery pipe may be provided at the same relative locations for each pack-installed location.

Bending pipes extending upward may be coupled to the pipe nipple. The cooling blocks may respectively include block nipples at opposite portions thereof and the block nipples may be coupled to the bending pipes.

The bending pipes and the block nipples may respectively have shut-off valves. When the bending pipes and the block nipples are coupled to each other, the shut-off valves may allow the refrigerant to flow. When the bending pipes and the block nipples are separated from each other, the shut-off valves may block the refrigerant from flowing.

A thermal interface material may be provided between a lower surface of each of the cooling blocks and an upper surface of each of the battery packs.

The refrigerant supply pipe and the refrigerant recovery pipe may be configured to circulate the refrigerant in parallel into the battery packs mounted to the pack-installed locations.

According to the present disclosure, the plurality of battery packs may be selectively mounted to the vehicle as necessary, and cooling may be selectively performed only for the mounted battery packs, so that energy efficiency of the vehicle can be maximized, output performance of the battery system can remain stable, and eventually marketability of electric vehicles can be significantly improved.

### BRIEF DESCRIPTION OF THE DRAWINGS

FIG. 1 is a perspective view illustrating a battery system for an electric vehicle according to one embodiment of the present disclosure;

FIG. 2 is a perspective view showing the battery system for an electric vehicle in FIG. 1 without cooling blocks;

FIG. 3 is an exploded perspective view of FIG. 2;

FIG. 4 is a view showing the battery system for an electric vehicle in FIG. 1 without a part of battery packs at a lower side of the battery system;

FIG. 5 is a view showing the battery system in FIG. 4, the view being taken from the lower side;

FIG. 6 is a view showing a refrigerant supply pipe and a refrigerant recovery pipe provided inside side members in FIG. 4;

FIGS. 7 to 9 are views successively showing a coupling structure and a coupling process of the refrigerant supply pipe or the refrigerant recovery pipe to the side members; and

FIG. 10 is a sectional view taken along line X-X in FIG. 1.

The drawings described herein are for illustration purposes only and are not intended to limit the scope of the present disclosure in any way.

### DETAILED DESCRIPTION

Hereafter, embodiments of the present disclosure are described in detail with reference to the accompanying drawings and the same or similar components are given the same reference numerals regardless of the numbers of figures and are not repeatedly described.

The suffixes “module” and “part” for the components used in the following description are given or mixed in consideration of only the ease of writing the specification, and do not have distinct meanings or roles by themselves.

In the following description, if it is decided that the detailed description of known technologies related to the present disclosure makes the subject matter of the embodiment described herein unclear, the detailed description is omitted. Furthermore, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Singular forms are intended to include plural forms unless the context clearly indicates otherwise.

It should be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof. When a component, device, element, or the like of the present disclosure is described as having a purpose or performing an operation, function, or the like, the component, device, or element should be considered herein as being “configured to” meet that purpose or to perform that operation or function.

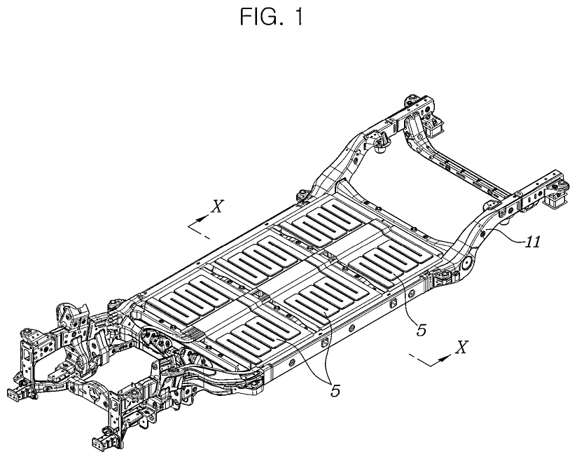

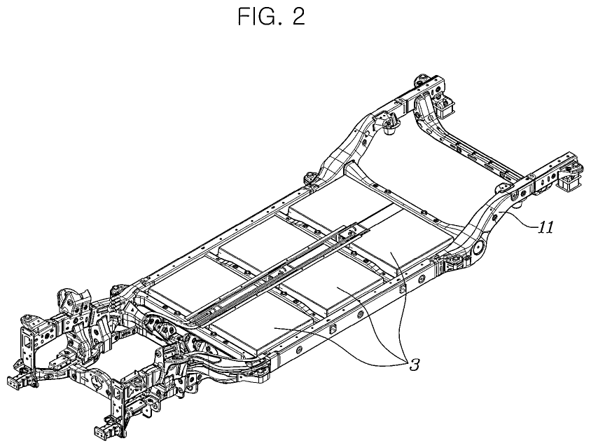

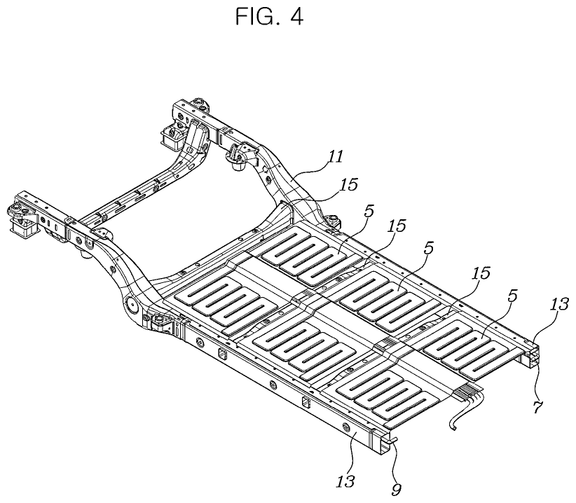

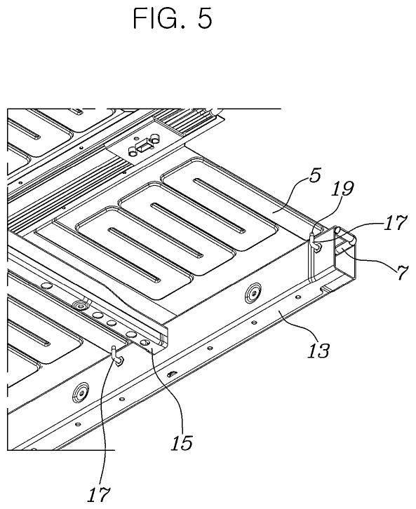

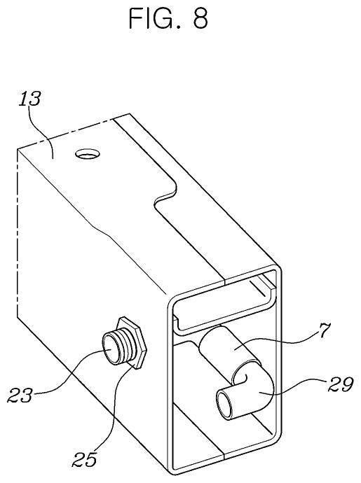

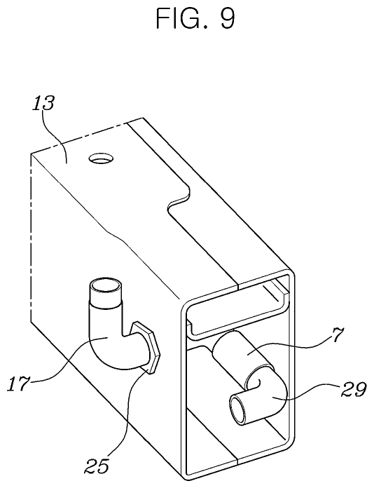

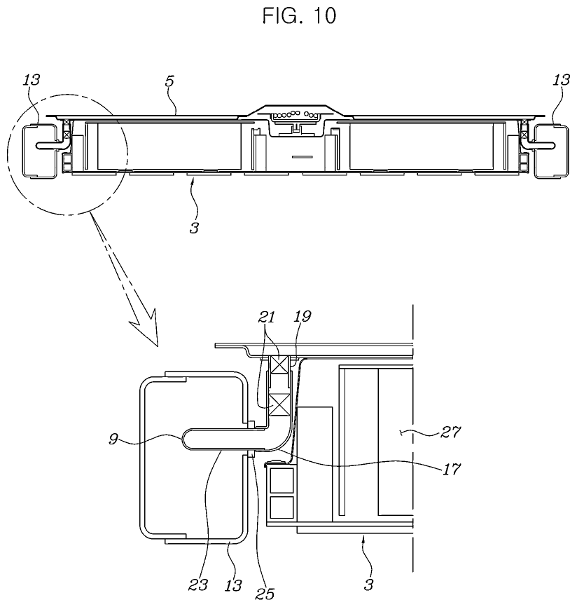

Referring to FIGS. 1 to 10, according to an embodiment of the present disclosure, a battery system for an electric vehicle includes: a plurality of battery packs 3 mounted, in an interchangeable manner, to a plurality of pack-installed locations 1 successively arranged in a longitudinal direction of a vehicle. The battery system further includes: a plurality of cooling blocks 5 provided respectively above the battery packs 3; and a refrigerant supply pipe 7 arranged at a first side of the plurality of pack-installed locations 1 while extending in the longitudinal direction of the vehicle, and configured to supply a refrigerant to the cooling blocks 5. The battery system further includes: a refrigerant recovery pipe 9 arranged at a second side of the plurality of pack-installed locations 1 while extending in the longitudinal direction of the vehicle, and configured to recover the refrigerant from the cooling blocks 5.

In one embodiment, the cooling blocks 5 and the refrigerant supply pipe 7, and the cooling blocks 5 and the refrigerant recovery pipe 9 are provided so that a supplying state and a blocking state of the refrigerant are switched to each other by vertical relative displacement of the cooling blocks 5 to the refrigerant supply pipe 7 and the refrigerant recovery pipe 9. In other words, the cooling blocks 5, the refrigerant supply pipe 7, and the refrigerant recovery pipe 9 can transition between refrigerant supplying and blocking states based on the vertical displacement of the cooling blocks 5 relative to the refrigerant supply pipe 7 and the refrigerant recovery pipe 9.

In one embodiment of the present disclosure, the plurality of battery packs 3 is selectively mounted to the plurality of pack-installed locations 1 arranged in the longitudinal direction of the vehicle. The cooling blocks 5 are located above every battery pack 3 for cooling heat generated from the battery packs 3, and a connected state of the cooling blocks 5 (i.e., the state in which the refrigerant is supplied or blocked) is switched by the vertical relative displacement to the refrigerant supply pipe 7 and the refrigerant recovery pipe 9, so that the cooling blocks 5 can be easily attached and detached to match the number of the battery packs 3 mounted to the vehicle.

The pack-installed locations 1 are spaces that are partitioned by side members 13 and a plurality of cross members 15. The side members 13 constitute a frame 11 of the vehicle and are arranged at opposite portions of the frame while extending long in the longitudinal direction, and the plurality of cross members 15 are arranged while extending in a transverse direction of the vehicle to connect the side members 13 to each other.

Furthermore, all of the battery packs 3 are formed with the same standard, and may be selectively mounted to the pack-installed locations 1 as described above.

Therefore, when the vehicle is mainly used in short-distance driving, one of the battery packs 3 is mounted only to one of the plurality of pack-installed locations 1 to significantly reduce the weight of the vehicle, so that unnecessary energy consumption in vehicle operation can be reduced.

Furthermore, when the vehicle is mainly used in long-distance driving, the vehicle, all of the battery packs 3 are mounted to the plurality of pack-installed locations 1 to significantly increase a cruising distance of the vehicle, so that usability of the vehicle can be maximized.

As described above, when the battery packs 3 are selectively mounted to the plurality of pack-installed locations 1 provided in the frame 11 of the vehicle, the cooling blocks 5 are selectively mounted to the vehicle to cool only for the battery packs 3, which are mounted to the vehicle. Accordingly, with the refrigerant flowing only into the mounted cooling blocks 5, optimal cooling performance of the battery packs 3 mounted to the vehicle can be ensured, unnecessary flow of the refrigerant can be prevented, and only necessary flow of the refrigerant are performed. Eventually, energy efficiency of the vehicle can be maximized.

Therefore, when the number of the battery packs 3 mounted is changed according to use change of the vehicle, a body is separated from the frame 11 of the vehicle, and then the cooling blocks 5 are selectively mounted only above the pack-installed locations 1 with the battery packs 3 mounted, otherwise the cooling blocks 5 mounted above the pack-installed locations 1 without the battery packs 3 mounted may be selected removed.

For reference, in one embodiment, the battery packs 3 may be mounted to the cross members 15 of the frame 11.

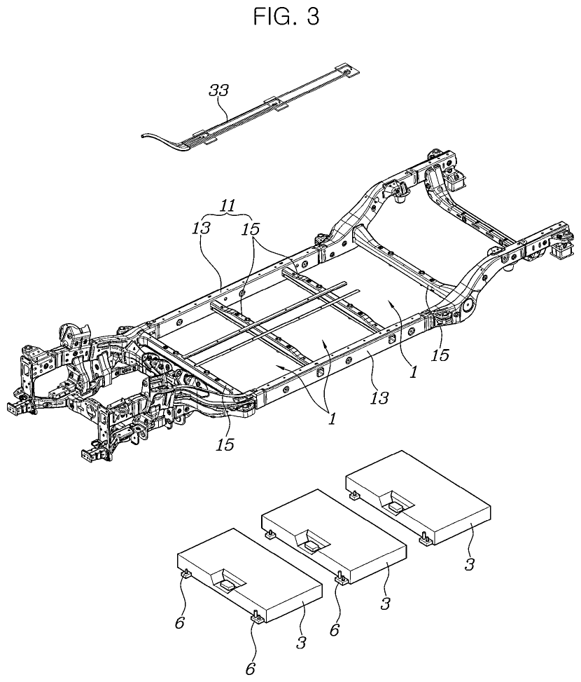

In FIG. 3, forward-protruding portions of the battery packs 3 may be coupling parts 6 provided to mount the battery packs 3 to the cross members 15, and of course, rear portions of the battery packs 3 also have the coupling parts 6 same as the front coupling parts 6.

In other words, in the embodiment, the cross members 15 of the frame 11 serve as structural support members to which the battery packs 3 are mounted, and the side members 13 of the frame 11 serve to store the refrigerant supply pipe 7 and the refrigerant recovery pipe 9 that supply and recover the refrigerant to and from the cooling blocks 5.

The refrigerant supply pipe 7 and the refrigerant recovery pipe 9 are respectively installed inside the side members 13 at the opposite sides.

Upward bending pipes 17 are respectively connected to the refrigerant supply pipe 7 and the refrigerant recovery pipe 9, each of the upward bending pipes 17 being arranged for each pack-installed location 1, so that the refrigerant supply pipe 7 and the refrigerant recovery pipe 9 are connected to the cooling blocks 5 through in-vehicle body portions of the side members 13.

Furthermore, each of the cooling blocks 5 has block nipples 19 at opposite portions thereof and the block nipples 19 allow each of the cooling blocks 5 to be attachable and detachable to the bending pipe 17 of the refrigerant supply pipe 7 and the bending pipe 17 of the refrigerant recovery pipe 9 by moving vertically against the frame 11.

Therefore, when the cooling blocks 5 move upwards from the refrigerant supply pipe 7 and the refrigerant recovery pipe 9, the block nipples 19 of the cooling blocks 5 are removed from the bending pipes 17 so that the cooling blocks 5 are separated from the refrigerant supply pipe 7 and the refrigerant recovery pipe 9. When the cooling blocks 5 move downwards, the block nipples 19 located at the opposite portions of the cooling blocks 5 are coupled to the bending pipes 17, so that the cooling blocks 5 are connected to the refrigerant supply pipe 7 and the refrigerant recovery pipe 9.

The bending pipes 17 and the block nipples 19 respectively have shut-off valves 21. When the bending pipes 17 and the block nipples 19 are coupled to each other, the shut-off valves 21 allow the refrigerant to pass through the bending pipes 17 and the block nipples 19, and when the bending pipes 17 and the block nipples 19 are separated from each other, the shut-off valves 21 block the refrigerant from flowing.

Therefore, as described above, even when the cooling blocks 5 are separated from the refrigerant supply pipe 7 and the refrigerant recovery pipe 9, the refrigerant is prevented from leaking from the cooling blocks 5, the refrigerant supply pipe 7, and the refrigerant recovery pipe 9, and the cooling blocks 5 can be easily separated from and mounted to the refrigerant supply pipe 7 and the refrigerant recovery pipe 9.

For reference, the shut-off valves 21 may use methods that can be opened and closed by vertical displacement of the cooling blocks 5 to the refrigerant supply pipe 7 and the refrigerant recovery pipe 9.

The refrigerant supply pipe 7 and the refrigerant recovery pipe 9 include pipe nipples 23 having screw threads on outer circumferential surfaces thereof, and the pipe nipples 23 penetrate through the side members 13 to be coupled to the bending pipes 17. Fixing nuts 25 are coupled to the screw threads of the pipe nipples 23 to fix the refrigerant supply pipe 7 and the refrigerant recovery pipe 9 to the side members 13.

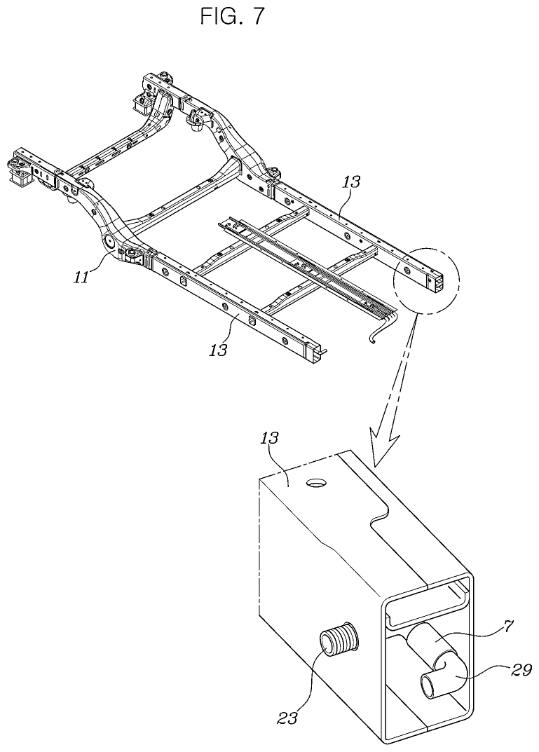

For reference, FIGS. 7 to 9 are views successively showing a process in which the pipe nipples 23 provided at the refrigerant supply pipe 7 and the refrigerant recovery pipe 9 are fixed by the fixing nuts 25 while penetrating through the inner walls of the side members 13 as described above.

As described above, the refrigerant supply pipe 7 and the refrigerant recovery pipe 9 are provided inside the side members 13, and the refrigerant flows into the pack-installed locations 1 through the pipe nipples 23, and therefore, the pack-installed locations 1 are not reduced due to the refrigerant supply pipe 7 and the refrigerant recovery pipe 9 and the battery packs 3 can include more battery modules 27.

A thermal interface material (TIM) is provided between the cooling blocks 5 and the battery packs 3, so that the battery packs 3 can be further efficiently cooled.

The refrigerant supply pipe 7 and the refrigerant recovery pipe 9 are configured to supply, by the refrigerant supply pipe 7, cooled refrigerant and further configured to recover, by the refrigerant recovery pipe 9, heated refrigerant with a separate refrigerant circulating device, etc. connected thereto.

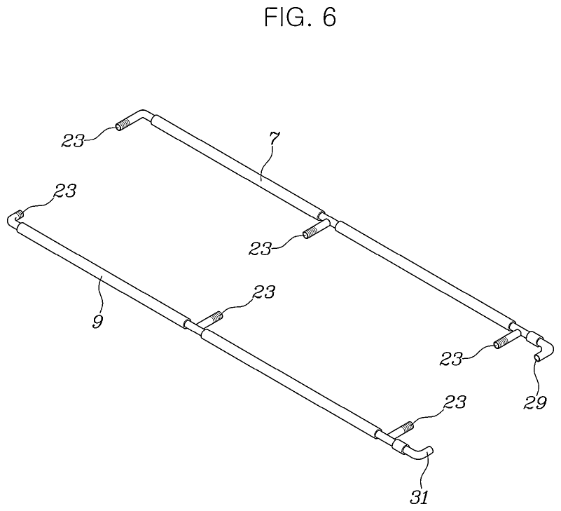

For reference, FIG. 6 is a view showing the refrigerant supply pipe 7 having a main supply nipple 29 to which the refrigerant circulating device is connected, and the refrigerant recovery pipe 9 having a main recover nipple 31 to which the refrigerant circulating device is connected.

For reference, from FIG. 3, the reference numeral 33 presents wiring to build electrical connection of the battery packs mounted to the vehicle.

The present disclosure as described above is further described as follows.

In other words, the battery system for an electric vehicle according to the embodiment of the present disclosure includes: the frame 11 providing the plurality of pack-installed locations 1 in the longitudinal direction of the vehicle by the plurality of cross members 15 connecting one of the two side members 13 to the other; one or more battery pack 3 formed in the plurality of pack-installed locations 1 in an exchangeable manner; the cooling blocks 5 separately provided for the pack-installed locations 1 to perform heat conduction with upper surfaces of the battery packs 3; and the refrigerant flow apparatus provided in the frame 11 to supply and recover the refrigerant that circulates through the cooling blocks 5.

The refrigerant flow apparatus is provided in each of the two side members 13 of the frame 11, and may include the refrigerant supply pipe 7 and the refrigerant recovery pipe 9 that are configured to send and receive the refrigerant to and from the cooling blocks 5.

The refrigerant supply pipe 7 and the refrigerant recovery pipe 9 have the plurality of pipe nipples 23 that penetrate through the in-vehicle body surfaces of the side members 13. The fixing nuts 25 are fastened to the pipe nipples 23, so that the refrigerant supply pipe 7 and the refrigerant recovery pipe 9 are fixed to the side members 13.

Each of the pipe nipples 23 of the refrigerant supply pipe 7 and each of the pipe nipples 23 of the refrigerant recovery pipe 9 are respectively located the same respective locations in each of the pack-installed locations 1.

For example, the same respective locations may be understood as locations spaced apart by a predetermined distance from mounting locations of the battery packs 3 mounted to the pack-installed locations 1. Even when the plurality of pack-installed locations 1 have forms that do not completely match each other, the pipe nipples 23 are installed at locations where the upper surfaces of the battery packs 3 mounted to the pack-installed locations 1 and lower surfaces of the cooling blocks 5 precisely match each other.

The bending pipes 17 upward extending are coupled to the pipe nipples 23, and the cooling blocks 5 may have the block nipples 19 coupled to the bending pipes 17 at the opposite portions thereof.

The bending pipes 17 and the block nipples 19 respectively have the shut-off valves 21, and when the bending pipes 17 and the block nipples 19 are coupled to each other, the shut-off valves 21 allow the refrigerant to flow. When the bending pipes 17 and the block nipples 19 are separated from each other, the shut-off valves 21 block the refrigerant from flowing.

A thermal interface material (TIM) may be provided between a lower surface of each of the cooling blocks 5 and an upper surface of each of the battery packs 3.

The refrigerant supply pipe 7 and the refrigerant recovery pipe 9 are configured to circulate the refrigerant in parallel into the battery packs 3 mounted to the pack-installed locations 1.

Although the present disclosure was provided above in relation to specific embodiments shown in the drawings, it is apparent to those having ordinary skill in the art that the present disclosure may be changed and modified in various ways without departing from the scope of the present disclosure, which is provided in the following claims.

1. A battery system for an electric vehicle, the battery system comprising:
a plurality of battery packs mounted, in an interchangeable manner, to a plurality of pack-installed locations successively arranged in a longitudinal direction of the electric vehicle;
a plurality of cooling blocks provided respectively above the plurality of battery packs;
a refrigerant supply pipe arranged at a first side of the plurality of pack-installed locations while extending in the longitudinal direction of the electric vehicle, the refrigerant supply pipe configured to supply a refrigerant to the plurality of cooling blocks; and
a refrigerant recovery pipe arranged at a second side of the plurality of pack-installed locations while extending in the longitudinal direction of the electric vehicle, the refrigerant recovery pipe configured to recover the refrigerant from the plurality of cooling blocks.

2. The battery system of claim 1, wherein the plurality of cooling blocks and the refrigerant supply pipe, and the plurality of cooling blocks and the refrigerant recovery pipe are arranged so that a refrigerant supplying state and a refrigerant blocking state are switched from each other according to a vertical relative displacement of the plurality of cooling blocks to the refrigerant supply pipe and the refrigerant recovery pipe.

3. The battery system of claim 2, wherein the plurality of pack-installed locations are spaces partitioned by:
side members constituting a frame of the electric vehicle and arranged at opposite portions of the frame while extending in the longitudinal direction; and
a plurality of cross members arranged while extending in a transverse direction of the electric vehicle to connect the opposite side members to each other.

4. The battery system of claim 3, wherein the refrigerant supply pipe and the refrigerant recovery pipe are respectively installed inside the opposite side members.

5. The battery system of claim 4, wherein upward bending pipes are respectively connected to the refrigerant supply pipe and the refrigerant recovery pipe, each bending pipe being arranged for each pack-installed location, so that the refrigerant supply pipe and the refrigerant recovery pipe are connected to the plurality of cooling blocks through in-vehicle body portions of the opposite side members.

6. The battery system of claim 5, wherein each of the plurality of cooling blocks includes block nipples at opposite portions thereof and the block nipples allow each of the plurality of cooling blocks to be removably coupled to the bending pipe of the refrigerant supply pipe and the bending pipe of the refrigerant recovery pipe by moving vertically against the frame.

7. The battery system of claim 6, wherein:
the bending pipes and the block nipples respectively include shut-off valves,
when the bending pipes and the block nipples are coupled to each other, the shut-off valves allow the refrigerant to flow, and
when the bending pipes and the block nipples are separated from each other, the shut-off valves block the refrigerant from flowing.

8. The battery system of claim 6, wherein the refrigerant supply pipe and the refrigerant recovery pipe respectively comprise pipe nipples having screw threads on outer circumferential surfaces thereof, and the pipe nipples penetrate through the opposite side members to be coupled to the bending pipes; and
fixing nuts are coupled to the screw threads of the pipe nipples, and fix the refrigerant supply pipe and the refrigerant recovery pipe to the opposite side members.

9. The battery system of claim 6, wherein a thermal interface material is provided between each of the plurality of cooling blocks and each of the plurality of battery packs.

10. A battery system for an electric vehicle, the battery system comprising:
a frame providing a plurality of pack-installed locations in a longitudinal direction of the electric vehicle by a plurality of cross members connecting at least two side members to each other;
one or more battery packs provided in the plurality of pack-installed locations in an exchangeable manner;
cooling blocks separately provided for the plurality of pack-installed locations to perform heat conduction with upper surfaces of the one or more battery packs; and
a refrigerant flow apparatus provided in the frame to supply and recover a refrigerant that circulates through the cooling blocks.

11. The battery system of claim 10, wherein the refrigerant flow apparatus comprises a refrigerant supply pipe and a refrigerant recovery pipe provided in the at least two side members of the frame and configured to send and receive the refrigerant to and from the cooling blocks, respectively.

12. The battery system of claim 11, wherein:
the refrigerant supply pipe and the refrigerant recovery pipe respectively have a plurality of pipe nipples that penetrate through in-vehicle body surfaces of the at least two side members; and
fixing nuts are fastened to the plurality of pipe nipples to fix the refrigerant supply pipe and the refrigerant recovery pipe to the at least two side members.

13. The battery system of claim 12, wherein each pipe nipple provided in the refrigerant supply pipe and each pipe nipple provided in the refrigerant recovery pipe are provided at the same relative locations for each pack-installed location.

14. The battery system of claim 13, wherein:
bending pipes extending upward are coupled to the pipe nipple; and
the cooling blocks respectively comprise block nipples at opposite portions thereof and the block nipples are coupled to the bending pipes.

15. The battery system of claim 14, wherein:
the bending pipes and the block nipples respectively have shut-off valves,
when the bending pipes and the block nipples are coupled to each other, the shut-off valves allow the refrigerant to flow, and
when the bending pipes and the block nipples are separated from each other, the shut-off valves block the refrigerant from flowing.

16. The battery system of claim 10, wherein a thermal interface material is provided between a lower surface of each of the cooling blocks and an upper surface of each of the one or more battery packs.

17. The battery system of claim 11, wherein the refrigerant supply pipe and the refrigerant recovery pipe are configured to circulate the refrigerant in parallel into the one or more battery packs mounted to the plurality of pack-installed locations.
